(19) United States
(12) Patent Application Publication
(10) Pub. No.: US 2025/0102960 A1
(43) Pub. Date: Mar. 27, 2025

(54) DEVELOPING UNIT AND IMAGE FORMING APPARATUS

(71) Applicant: FUJIFILM BUSINESS INNOVATION CORP., Tokyo (JP)

(72) Inventor: Kenta URAYAMA, Kanagawa (JP)

(73) Assignee: FUJIFILM BUSINESS INNOVATION CORP., Tokyo (JP)

(21) Appl. No.: 18/441,206

(22) Filed: Feb. 14, 2024

(30) Foreign Application Priority Data
Sep. 27, 2023 (JP) 2023-165016

(51) Int. Cl. G03G 15/08

(52) U.S. Cl. CPC G03G 15/0898; G03G 15/0812; G03G 15/0818

(57) ABSTRACT

A developing unit includes: a developer holding member that holds developer to be supplied to an image carrier on which an electrostatic latent image is formed, the developer containing toner and carrier, and that includes at least one developer attracting magnet; a covering member that covers a part of the developer holding member; and a film that is attached to the covering member at ends and an intermediate position of the film in a circumferential direction of the developer holding member so as to be in contact with the developer held on the developer holding member.

### CROSS-REFERENCE TO RELATED APPLICATIONS

This application is based on and claims priority under 35 USC 119 from Japanese Patent Application No. 2023-165016 filed Sep. 27, 2023.

### BACKGROUND

### (i) Technical Field

The present disclosure relates to a developing unit and an image forming apparatus.

### (ii) Related Art

For example, Japanese Unexamined Patent Application Publication No. 2016-139111 discloses a developing device including: a developer carrier opposed to a latent image carrier; a developer regulating member; and a casing member. The developing device includes a first seal member, a second seal member, and a third seal member. The first seal member is held by the casing member at one end thereof, and is in contact with the surface of the latent image carrier at the other end thereof at a position on the upstream side of a developing region in a surface movement direction of the latent image carrier. The second seal member is held on a surface of the casing member facing the developer carrier at one end thereof, and is in contact with the first seal member at the other end thereof at a position on the upstream side of the developing region in the surface movement direction of the developer carrier. The third seal member is held on the surface of the casing member facing the developer carrier at one end thereof, and the other end of the third seal member hangs down due to its own weight. The other end is in contact with the developer on the developer carrier that has passed through a regulating position where developer is regulated by the developer regulating member, at a position on the upstream side of the developing region in the surface movement direction of the developer carrier.

### SUMMARY

In order to prevent toner from floating and soiling components surrounding a developer holding member that holds developer including toner and carrier, a covering member for covering a part of the developer holding member may be provided. When the toner accumulates on the side of the covering member facing the developer holding member and forms a lump, the lump may fall off from the covering member, producing an image defect. When the occurrence of such a lump is suppressed by providing, on the covering member, a film that comes into contact with the developer held on the developer holding member, it is desirable to prevent a situation in which it is difficult to maintain a contact state between the film and the developer layer. Otherwise, toner accumulation may occur.

Aspects of non-limiting embodiments of the present disclosure relate to suppressing the occurrence of toner accumulation, compared with a case where the structure for preventing a situation in which it is difficult to maintain a contact state between the film and the developer layer on the developer holding member is not employed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing unit including: a developer holding member that holds developer to be supplied to an image carrier on which an electrostatic latent image is formed, the developer containing toner and carrier, and that includes at least one developer attracting magnet; a covering member that covers a part of the developer holding member; and a film that is attached to the covering member at ends and an intermediate position of the film in a circumferential direction of the developer holding member so as to be in contact with the developer held on the developer holding member.

### BRIEF DESCRIPTION OF THE DRAWINGS

Exemplary embodiments of the present disclosure will be described in detail based on the following figures, wherein:

FIG. 1 illustrates an image forming apparatus;

FIG. 2 illustrates a developing device of the image forming apparatus;

FIG. 3 is a perspective view illustrating a more detailed structure of the developing device;

FIG. 4 illustrates magnetic poles of a magnet roller of a developing roller;

FIG. 5 illustrates a film provided on an inner surface of a cover member;

FIGS. 6A and 6B illustrate positions of the film attached to the cover member, in which FIG. 6A illustrates a case where the film is attached to a predetermined position, and FIG. 6B illustrates a case where the film is attached at a position shifted from the predetermined position; and

FIG. 7 is a perspective view illustrating an inner surface of the cover member.

### DETAILED DESCRIPTION

An exemplary embodiment of the present disclosure will be described in detail below with reference to the accompanying drawings.

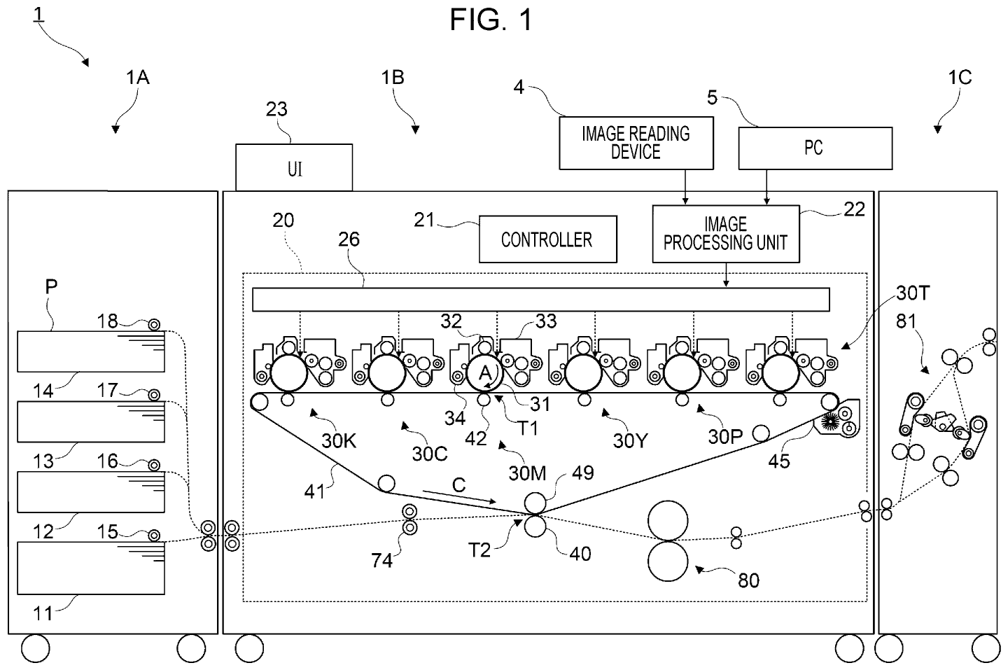

FIG. 1 illustrates an image forming apparatus 1.

The image forming apparatus 1 according to this exemplary embodiment includes a sheet feed unit 1A, a printing unit 1B, and a sheet discharge unit 1C.

The sheet feed unit 1A includes first to fourth sheet containers 11 to 14 that store sheets P, which are an example of a recording medium.

The sheet feed unit 1A also includes feed rollers 15 to 18, which are provided corresponding to the first to fourth sheet containers 11 to 14, respectively, that feed the sheets P stored in the sheet containers to a transport path connected to the printing unit 1B.

The printing unit 1B includes an image forming section 20 that forms an image on a sheet P. The printing unit 1B also includes a controller 21 that controls the respective parts of the image forming apparatus 1.

The printing unit 1B also includes an image processing unit 22. The image processing unit 22 performs image processing on image data transmitted from an image reading device 4 or a personal computer (PC) 5.

The printing unit 1B also includes a user interface (UI) 23, including a touch panel, that notifies a user of information and receives input of information from the user.

The image forming section 20, which is an example of an image forming component, includes six image forming units 30T, 30P, 30Y, 30M, 30C, and 30K (hereinbelow, sometimes simply referred to as “image forming units 30”) arranged in parallel at regular intervals.

Each of the image forming units 30 includes: a photoconductor drum 31 on which an electrostatic latent image is formed while the photoconductor drum 31 is rotating in the direction of arrow A; a charging roller 32 that charges the surface of the photoconductor drum 31; a developing unit 33 that develops the electrostatic latent image formed on the photoconductor drum 31; and a drum cleaner 34 that removes toner and other particles on the surface of the photoconductor drum 31.

The photoconductor drum 31 is an example of an image carrier.

The image forming section 20 includes a laser exposure device 26 that radiates laser beams onto the photoconductor drums 31 of the image forming units 30.

The light used by the laser exposure device 26 to expose the photoconductor drums 31 is not limited to the laser beams. For example, a light source such as a light emitting diode (LED) may be provided for each of the image forming units 30, and the photoconductor drums 31 may be exposed to the light emitted from these light sources.

The image forming units 30 have the same structure except for the toner stored in the developing units 33. The image forming units 30Y, 30M, 30C, and 30K form yellow (Y), magenta (M), cyan (C), and black (K) toner images, respectively.

The image forming units 30T and 30P form toner images using toners corresponding to corporate colors, foaming toners for Braille, fluorescent color toners, gloss-enhancing toners, and the like. In other words, the image forming units 30T and 30P form toner images using special color toners.

The image forming section 20 includes an intermediate transfer belt 41 to which color toner images formed on the photoconductor drums 31 of the respective image forming units 30 are transferred.

The image forming section 20 also includes first transfer rollers 42 for transferring the color toner images formed by the image forming units 30 to the intermediate transfer belt 41 at first transfer parts T1.

The image forming section 20 also includes a second transfer roller 40 for collectively transferring the toner images transferred onto the intermediate transfer belt 41 to a sheet P at a second transfer part T2.

The image forming section 20 further includes a belt cleaner 45 for removing toner and other particles on the surface of the intermediate transfer belt 41, and a fixing device 80 for fixing, to the sheet P, the image that has been second-transferred to the sheet P.

The image forming section 20 performs an image forming operation in response to a control signal from the controller 21.

Specifically, in the image forming section 20, the image processing unit 22 performs image processing on an image data input from the image reading device 4 or the PC 5, and the processed image data is supplied to the laser exposure device 26.

For example, in the image forming unit 30M for magenta (M), the charging roller 32 charges the surface of the photoconductor drum 31. Then, the laser exposure device 26 radiates a laser beam modulated according to the image data obtained from the image processing unit 22 onto the photoconductor drum 31.

As a result, an electrostatic latent image is formed on the photoconductor drum 31.

The electrostatic latent image is then developed by the developing unit 33, and a magenta toner image is formed on the photoconductor drum 31.

Similarly, yellow, cyan, and black toner images are formed in the image forming units 30Y, 30C, and 30K, respectively, and special color toner images are formed in the image forming units 30T and 30P.

The color toner images formed in the image forming units 30 are sequentially electrostatically transferred to the intermediate transfer belt 41 running in the direction of arrow C in FIG. 1 by the first transfer rollers 42, whereby a superimposed toner image is formed on the intermediate transfer belt 41.

The superimposed toner image formed on the intermediate transfer belt 41 is transported to the second transfer part T2, including the second transfer roller 40 and a backup roller 49, as the intermediate transfer belt 41 runs.

Meanwhile, a sheet P is picked up from, for example, the first sheet container 11 by the feed roller 15 and is then transported to the position of registration rollers 74 via the transport path.

The registration rollers 74 feed the sheet P to the second transfer part T2, in accordance with the timing when the superimposed toner image is transported to the second transfer part T2.

Then, at the second transfer part T2, the superimposed toner image is electrostatically transferred to the sheet P by the action of a transfer electric field formed between the second transfer roller 40 and the backup roller 49.

The sheet P to which the superimposed toner image has been electrostatically transferred is then transported to the fixing device 80.

The fixing device 80 applies pressure and heat to the sheet P, which has the unfixed toner image, to fix the toner image to the sheet P.

After the fixing process, the sheet P passes through a curl corrector 81 provided in the sheet discharging unit 1C and is transported to a sheet stacker (not illustrated).

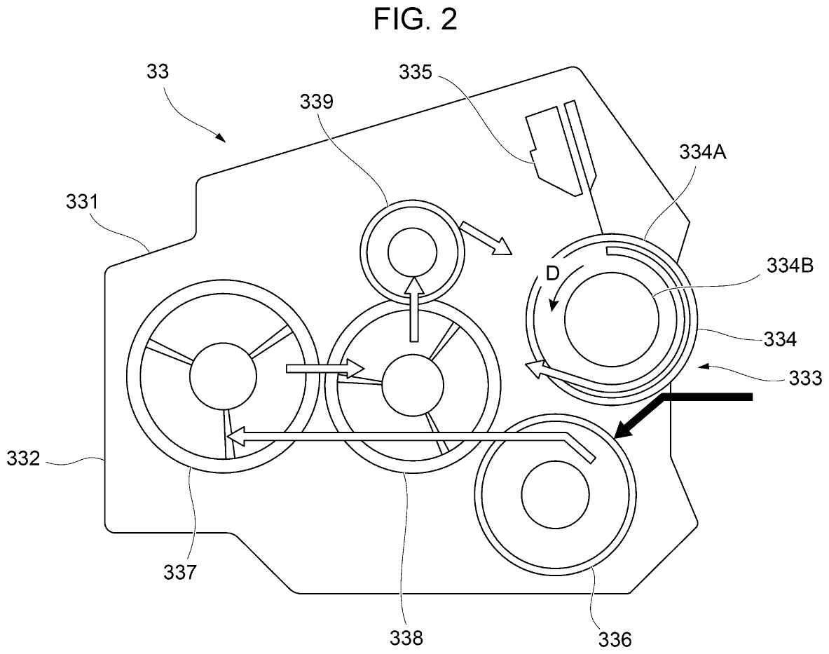

FIG. 2 illustrates the developing unit 33 of the image forming apparatus 1. FIG. 2 illustrates the developing unit 33 viewed from the rear side.

The developing unit 33 includes a container 331 for accommodating developer (not illustrated). The container 331 includes a container housing 332 made of resin.

The container housing 332 of the developing unit 33 is disposed so as to extend in a direction orthogonal to the plane of the drawing of FIG. 2, which corresponds to a direction from the front side to the rear side of the image forming apparatus 1 (see FIG. 1), with a far-side end (not illustrated) thereof located on the rear side and a near-side end (not illustrated) thereof located on the front side.

The container housing 332 has an opening 333 at a position facing the photoconductor drum 31 (see FIG. 1). A developing roller 334 that allows the developer to adhere to the surface of the photoconductor drum 31 is provided at the opening 333.

The developing roller 334, which is an example of a developer holding member, is formed in a cylindrical shape and is disposed so as to extend in the direction from the front side to the rear side of the image forming apparatus 1. In addition, the developing roller 334 is disposed so as to extend in the longitudinal direction of the developing unit 33.

The developing roller 334 includes a rotationally driven cylindrical developing sleeve 334A, and a magnet roller 334B disposed inside the developing sleeve 334A.

The developing sleeve 334A is made of metal, such as stainless steel. The developing sleeve 334A rotates in the direction of arrow D in FIG. 2.

The developing roller 334 is an example of a developer holding member.

Furthermore, in this exemplary embodiment, the developing sleeve 334A and the photoconductor drum 31 rotate such that the developing sleeve 334A and the photoconductor drum 31 move in the same direction, at the nip between the developing roller 334 and the photoconductor drum 31.

The developing unit 33 includes a layer regulating member 335 that regulates the thickness of the developer layer held on the developing roller 334.

As illustrated in FIG. 2, the developing unit 33 also includes a first transport member 336 and a second transport member 337 that transports the developer.

The first transport member 336 and the second transport member 337 are provided on the opposite side of the developing roller 334 from the side on which the photoconductor drum 31 (see FIG. 1) is disposed.

The first transport member 336 has a rotation shaft extending along the rotation shaft of the rotationally driven developing sleeve 334A, rotates about the rotation shaft, and transports the developer in the container 331.

In the developing unit 33 configured as above, new toner or toner to which a very small amount of carrier is added is circulated between the first transport member 336 and the second transport member 337 while being stirred. More specifically, the developer moves through connection ports provided at ends of a partition extending in the axial direction. This allows the developer stirred by the first transport member 336 to be stirred by the second transport member 337 and then by the first transport member 336 again. In the developing unit 33, circulation paths along which the toner circulates in the axial direction are formed by the rotation of the first transport member 336 and the rotation of the second transport member 337.

The developing unit 33 includes a third transport member 338 adjacent to the second transport member 337. The developing unit 33 also includes a pickup roller 339 provided above the third transport member 338.

A transport path formed by the rotation of the third transport member 338 is connected to the above-described circulation path and receives the developer from the above-described circulation path. The third transport member 338 supplies the developer to the pickup roller 339. The pickup roller 339 supplies the developer to the developing roller 334.

For example, the first transport member 336 transports the developer to the near side with respect to the plane of the drawing of FIG. 2, the second transport member 337 transports the developer to the far side with respect to the plane of the drawing of FIG. 2, and the third transport member 338 transports the developer to the near side with respect to the plane of the drawing of FIG. 2.

The developing roller 334, the layer regulating member 335, the first transport member 336, the second transport member 337, the third transport member 338, and the pickup roller 339 are disposed substantially parallel to the photoconductor drum 31 (see FIG. 1).

Next, a more detailed structure of the developing unit 33 will be described.

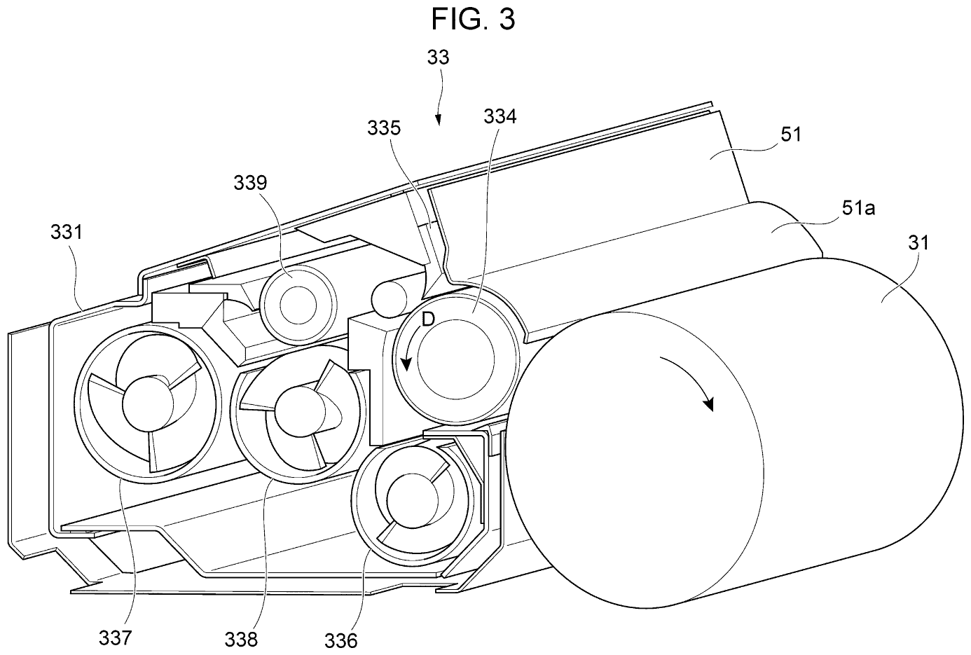

FIG. 3 is a perspective view illustrating a more detailed structure of the developing unit 33. In FIG. 3, the description of parts denoted by the same reference numerals as in FIG. 2 may be omitted.

As illustrated in FIG. 3, the developing unit 33 includes a cover member 51 having a convex part 51a, which has an arc-shaped cross-section, that covers a part of the pickup roller 339. The cover member 51 prevents the toner from floating and soiling the surrounding components and is an example of a covering member.

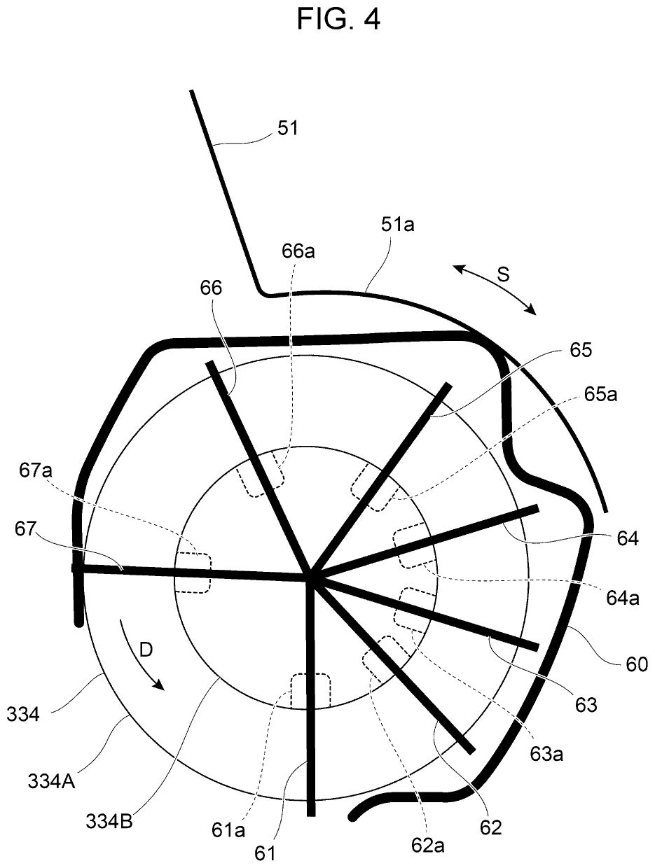

FIG. 4 illustrates the magnetic poles of the magnet roller 334B of the developing roller 334.

As illustrated in FIG. 4, the magnet roller 334B includes multiple magnetic poles arranged in the circumferential direction. More specifically, the magnet roller 334B includes seven magnetic poles 61a to 67a. FIG. 4 illustrates the arrangement of the magnetic poles, in which: a line segment 61 indicates the position of the first magnetic pole 61a, a line segment 62 indicates the position of the second magnetic pole 62a, a line segment 63 indicates the position of the third magnetic pole 63a, a line segment 64 indicates the position of the fourth magnetic pole 64a, a line segment 65 indicates the position of the fifth magnetic pole 65a, a line segment 66 indicates the position of the sixth magnetic pole 66a, and a line segment 67 indicates the position of the seventh magnetic pole 67a.

By arranging the magnetic poles 61a to 67a in this manner, a magnetic attraction distribution 60 in the normal direction, indicated by the thick line, is set. The magnetic attraction distribution 60 indicates that the thickness of a developer layer, that is, the height of the layer from the surface of the developing roller 334, varies depending on the position in the circumferential direction S of the developing roller 334. As illustrated in FIG. 4, in the magnetic attraction distribution 60, the developer layer is high at, for example, the positions corresponding to the line segments 64 and 65 where the magnetic poles 64a and 65a are located, and the developer layer is low at, for example, the position between the adjacent magnetic poles 64a and 65a, that is, the position between the line segments 64 and 65.

As described above, the height of the developer layer on the developing roller 334 varies in the circumferential direction S.

The magnetic poles 64a and 65a are an example of attracting magnets.

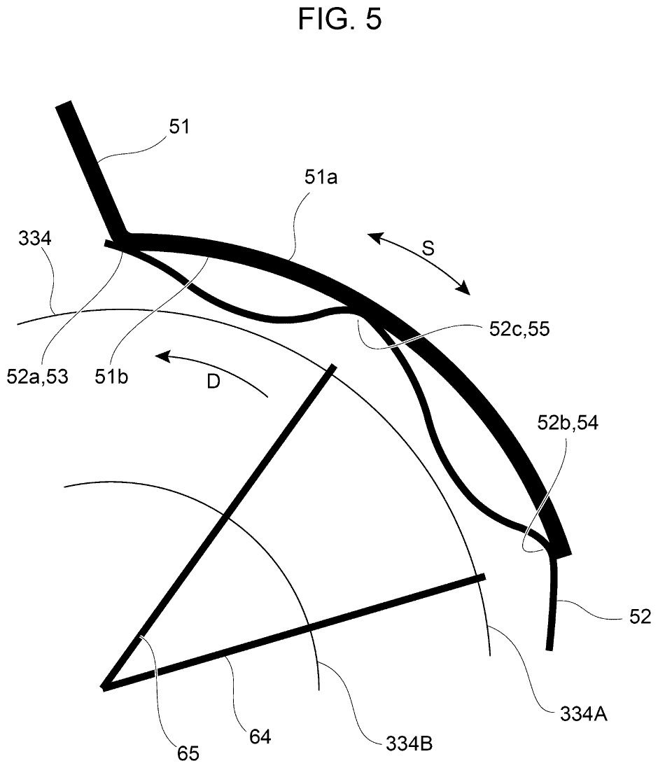

FIG. 5 illustrates a film 52 provided on an inner surface 51b of the cover member 51.

As illustrated in FIG. 5, the film 52 is provided on the inner surface 51b of the cover member 51.

The film 52 is provided on the inner surface 51b of the cover member 51 with an adhesive tape 53 attached to an end 52a of the film 52 and an adhesive tape 54 attached to an end 52b of the film 52.

Desirably, the film 52 is a soft and flexible member. The film 52 may be made of, for example, a urethane-based material and has a thickness of, for example, 50 to 200 μm.

In addition, an adhesive tape 55 is attached to an intermediate part 52c located between the end 52b and the end 52c of the film 52 in the circumferential direction S of the developing roller 334. The position of the intermediate part 52c is an example of an intermediate position in the circumferential direction.

The adhesive tapes 53 to 55 are double-sided adhesive tapes having adhesive surfaces on both sides, and are all provided between the inner surface 51b of the cover member 51 and the film 52. Therefore, the film 52 is positioned between the developing roller 334 and the cover member 51 in the radial direction of the developing roller 334, and there is no gap, which allows the entry of toner, between the film 52 and the cover member 51.

More specifically, the end 52b, to which the adhesive tape 54 is attached, is located at the position corresponding to the line segment 64, and the intermediate part 52c, to which the adhesive tape 55 is attached, is located at the position corresponding to the line segment 65. The distance between the developing roller 334 and the film 52 is large at the positions where the adhesive tapes 54 and 55 are attached and is small at the position between these positions.

As described, the adhesive tapes 54 and 55 are attached at positions where the developer layer is high, so as to ensure a sufficient distance between the developing roller 334 and the film 52. More specifically, the adhesive tape 55 is attached to the intermediate part 52c, which is located at a position corresponding to the line segment 65, in addition to the adhesive tapes 53 and 54 attached to the ends 52b and 52b of the film 52. By doing so, even though the height of the developer layer varies in the circumferential direction, the film 52 comes into light contact with the developer layer.

This prevents a situation in which the toner accumulated on the inner surface 51b of the cover member 51 forms a lump and falls on the developing roller 334 (see FIG. 3), causing an image defect.

Although there is one intermediate part 52c to which the adhesive tape 55 is attached in this exemplary embodiment, there may be more than one intermediate part 52c.

Herein, the intermediate part 52c of the film 52 is a part of the film 52 to be attached to the cover member 51, at a position corresponding to the line segment 65 (the fifth magnetic pole 65a illustrated in FIG. 4), where the developer layer is high. The intermediate part 52c may be located at the central position or a position shifted from the central position of the film 52. The central position as used herein is the central position of the film 52 in the same direction as the circumferential direction S of the convex part 51a of the cover member 51.

In addition, the position of the intermediate part 52c of the film 52 is set according to the magnetic attraction distribution 60 (see FIG. 4), and it is determined whether the intermediate part 52c is set at the central position of the film 52. When the intermediate part 52c is set at the central position of the film 52, the shapes of the sags of the film 52 on the upstream side and the downstream side of the intermediate part 52c in the arrow D direction are the same.

More specifically, the intermediate part 52c of the film 52 is provided at such a position that the film 52 is in light contact with the developer layer. Hence, the intermediate part 52c may be set so as not to include the position where the height of the developer layer is lower than the height of the developer layer at the fourth magnetic pole 64a or the fifth magnetic pole 65a, for example, between the fourth magnetic pole 64a and the fifth magnetic pole 65a. Furthermore, the intermediate part 52c may be set at a position shifted from the position where the developer layer is high as described above, and the intermediate part 52c may be set so as to include the position where the developer layer is low as described above.

Furthermore, when there are more than one intermediate part 52c, the intermediate parts 52c may be set so as to include a position where the developer layer is high and a position where the developer layer is lower than that.

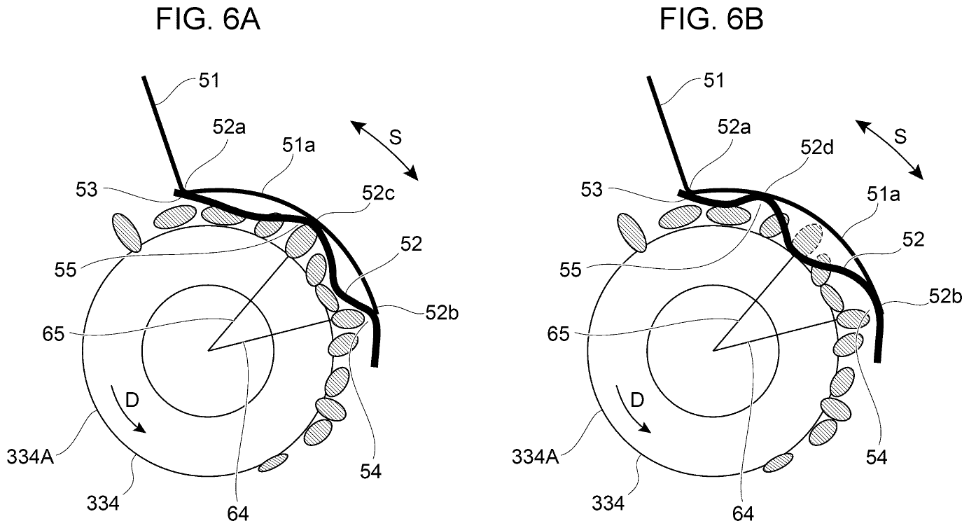

FIGS. 6A and 6B illustrate the attachment position of the film 52 with respect to the cover member 51, in which FIG. 6A illustrates a case where the attachment position is a predetermined position, and FIG. 6B illustrates a case where the attachment position is shifted from the predetermined position. In FIGS. 6A and 6B, the ellipses represent the developer layer.

As illustrated in FIG. 6A, when the film 52 is attached to the cover member 51 at the ends 52a and 52b with the adhesive tapes 53 and 54 and at the intermediate part 52c, which is the predetermined position, with the adhesive tape 55, the film 52 sags so as to conform to the height of the developer layer. Specifically, the film 52 sags in a shape conforming to the changes in the height of the developer layer in the circumferential direction of the developing roller 334.

The predetermined position as used herein is the position of the intermediate part 52c of the film 52, which is the central position of the film 52 corresponding to the position of the line segment 65 (for example, see FIG. 6A) in the circumferential direction S of the convex part 51a of the cover member 51.

In contrast, as illustrated in FIG. 6B, when the film 52 is attached to the cover member 51 not at the intermediate part 52c, which is the position set in advance corresponding to the line segment 65, but at a shifted position 52d closer to the end 52a with the adhesive tape 55, the shape of the sag of the film 52 does not conform to the height of the developer layer. Thus, the film 52 does not touch the developer layer, allowing the toner to be accumulated to a level higher than the magnetic attraction force distribution 60 (see FIG. 4) determined by the magnetic poles 61a to 67a. As a result, the toner may form a lump and fall on the developing roller 334 (see FIG. 3), causing an image defect.

As in this case, when the film 52 is attached to the cover member 51, if the adhesive tape 55 is attached at a position shifted from the predetermined position in addition to the ends 52a and 52b, the risk of the occurrence of image defects is higher than that in the case where the adhesive tape 55 is attached at the predetermined position. However, the risk of the occurrence of image defects is lower than that in the case where the film 52 is not provided.

The position in the cover member 51 at which intermediate part 52c of the film 52 is attached to the cover member 51 may be not only the central position of the cover member 51 in the circumferential direction S, but also a position shifted from the central position.

In this specification, “light contact” means that the film 52 is in contact with the developer layer such that a space in which toner accumulates is not formed between the film 52 and the developer layer, while preventing the film 52 from affecting the height of the developer layer on the developing roller 334.

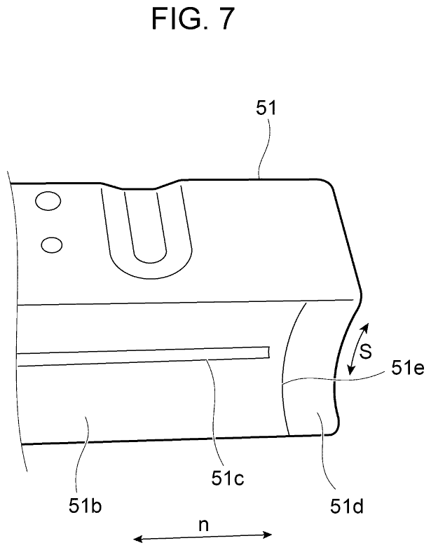

FIG. 7 is a perspective view illustrating the inner surface 51b of the cover member 51.

As illustrated in FIG. 7, a linear mark 51c is provided on the inner surface 51b of the cover member 51 to indicate the position to which the intermediate part 52c (see FIG. 5) of the film 52 is to be attached with the adhesive tape 55 (see FIG. 5).

The mark 51c extends in the longitudinal direction n of the cover member 51. This makes it easy to attach the film 52 to the cover member 51.

The longitudinal direction n is the same direction as the axial direction of the developing roller 334. The mark 51c is an example of a mark indicating the position to which the intermediate position of the film is to be attached.

Furthermore, a mark 51e corresponding to the position of an axial end 51d of the cover member 51, in the axial direction of the developing roller 334, is formed on the inner surface 51b of the cover member 51. The magnetic poles 64a and 65a (see, for example, FIG. 4) are not provided on the side closer to the end than the mark 51e is. Thus, the mark 51c is not formed on the side closer to the end than the mark 51e is. This makes it easy to attach the film 52 to the cover member 51.

The axial end 51d is an example of a region in the covering member corresponding to an end of the developer holding member.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A developing unit including: a developer holding member that holds developer to be supplied to an image carrier on which an electrostatic latent image is formed, the developer containing toner and carrier, and that includes at least one developer attracting magnet; a covering member that covers a part of the developer holding member; and a film that is attached to the covering member at ends and an intermediate position of the film in a circumferential direction of the developer holding member so as to be in contact with the developer held on the developer holding member.

(((2)))

The developing unit according to (((1))), wherein the intermediate position of the film is set according to the height of a developer layer determined by the developer attracting magnet provided in the developer holding member.

(((3)))

The developing unit according to (((2))), wherein the set intermediate position of the film includes a position in the film corresponding to the position of the developer attracting magnet where the developer layer is high.

(((4)))

The developing unit according to (((3))), wherein the set intermediate position of the film does not include a position in the film corresponding to the position between the developer attracting magnets where the developer layer is lower than at the positions corresponding to the developer attracting magnets.

(((5)))

The developing unit according to (((1))) or (((2))), wherein the film attached to the covering member sags in a shape conforming to a change in the height of the developer layer in the circumferential direction of the developer holding member.

(((6)))

The developing unit according to any one of (((1))) to (((5))), wherein the intermediate position of the film that is a central position of the film in the circumferential direction is attached to a central position of the covering member in the circumferential direction.

(((7)))

The developing unit according to any one of (((1))) to (((6))), wherein the covering member has a mark on a surface thereof facing the developer holding member, the mark indicating the position to which the intermediate position of the film is to be attached.

(((8)))

The developing unit according to (((7))), wherein the mark linearly extends in a longitudinal direction of the covering member.

(((9)))

The developing unit according to (((8))), wherein the linear mark is not formed in a region of the covering member corresponding to an end of the developer holding member where the developer attracting magnet in the developer holding member is not provided.

(((10)))

An image forming apparatus including: an image carrier on which an electrostatic latent image is formed; a developing unit that develops the electrostatic latent image formed on the image carrier into a toner image; a transfer unit that transfers the toner image formed by the developing unit to a recording material; and a fixing unit that fixes the toner image transferred to the recording material onto the recording material, wherein the developing unit includes: a developer holding member that holds developer to be supplied to the image carrier on which an electrostatic latent image is formed, the developer containing toner and carrier, and that includes at least one developer attracting magnet; a covering member that covers a part of the developer holding member; and a film that is attached to the covering member at ends and an intermediate position of the film in a circumferential direction of the developer holding member so as to be in contact with the developer held on the developer holding member.

What is claimed is:

1. A developing unit comprising:
a developer holding member that holds developer to be supplied to an image carrier on which an electrostatic latent image is formed, the developer containing toner and carrier, and that includes at least one developer attracting magnet;
a covering member that covers a part of the developer holding member; and
a film that is attached to the covering member at ends and an intermediate position of the film in a circumferential direction of the developer holding member so as to be in contact with the developer held on the developer holding member.

2. The developing unit according to claim 1, wherein the intermediate position of the film is set according to the height of a developer layer determined by the developer attracting magnet provided in the developer holding member.

3. The developing unit according to claim 2, wherein the set intermediate position of the film includes a position in the film corresponding to the position of the developer attracting magnet where the developer layer is high.

4. The developing unit according to claim 3, wherein the set intermediate position of the film does not include a position in the film corresponding to the position between the developer attracting magnets where the developer layer is lower than at the positions corresponding to the developer attracting magnets.

5. The developing unit according to claim 1, wherein the film attached to the covering member sags in a shape conforming to a change in the height of the developer layer in the circumferential direction of the developer holding member.

6. The developing unit according to claim 1, wherein the intermediate position of the film that is a central position of the film in the circumferential direction is attached to a central position of the covering member in the circumferential direction.

7. The developing unit according to claim 1, wherein the covering member has a mark on a surface thereof facing the developer holding member, the mark indicating the position to which the intermediate position of the film is to be attached.

8. The developing unit according to claim 7, wherein the mark linearly extends in a longitudinal direction of the covering member.

9. The developing unit according to claim 8, wherein the linear mark is not formed in a region of the covering member corresponding to an end of the developer holding member where the developer attracting magnet in the developer holding member is not provided.

10. An image forming apparatus comprising:
an image carrier on which an electrostatic latent image is formed;
a developing unit that develops the electrostatic latent image formed on the image carrier into a toner image;
a transfer unit that transfers the toner image formed by the developing unit to a recording material; and
a fixing unit that fixes the toner image transferred to the recording material onto the recording material,
wherein the developing unit includes:
a developer holding member that holds developer to be supplied to the image carrier on which an electrostatic latent image is formed, the developer containing toner and carrier, and that includes at least one developer attracting magnet;
a covering member that covers a part of the developer holding member; and
a film that is attached to the covering member at ends and an intermediate position of the film in a circumferential direction of the developer holding member so as to be in contact with the developer held on the developer holding member.
